(19) United States
(12) Patent Application Publication
(10) Pub. No.: US 2012/0019438 A1
(43) Pub. Date: Jan. 26, 2012

(54) DISPLAY DEVICE AND METHOD FOR ADJUSTING DISPLAY ORIENTATION THEREOF

(75) Inventor: MING-YANG LIAO, Tu-Cheng (TW)

(73) Assignee: HON HAI PRECISION INDUSTRY CO., LTD., Tu-Cheng (TW)

(21) Appl. No.: 12/961,900

(22) Filed: Dec. 7, 2010

(30) Foreign Application Priority Data
Jul. 23, 2010 (TW) 99124238

(51) Int. Cl. G09G 5/00

(52) U.S. Cl. 345/156

(57) ABSTRACT

A display device include a base, a display panel, a driving unit, an image capture unit, a feature detection unit, and a control unit. The display panel is rotatably mounted on the base. The driving unit rotates the display panel about a rotation axis relative to the base. The image capturing unit captures images of a scene in front of a front display surface of the display panel. The rotation axis of the display panel coincides with a central axis of the display panel. The feature detection unit detects a face portion of a user in the images, and determines a position of the face portion relative to the central line. The control unit controls the driving unit to rotate the display panel based on the position of the face portion so as to relocate the face portion in the images onto a central line of the image.

### BACKGROUND

1. Technical Field

The present disclosure relates to display devices and methods for adjusting display orientations thereof.

2. Description of Related Art

Generally, manual adjustment is required if a display orientation of a display device requires changing to improve viewing angle. However, this is inconvenient.

Therefore, a display device and a method for adjusting display orientation thereof, which can overcome the limitations described, is needed.

### BRIEF DESCRIPTION OF THE DRAWINGS

FIG. 1 is a schematic and isometric view of a display device, according to a first embodiment.

FIG. 2 is similar to FIG. 1, but viewed from another angle.

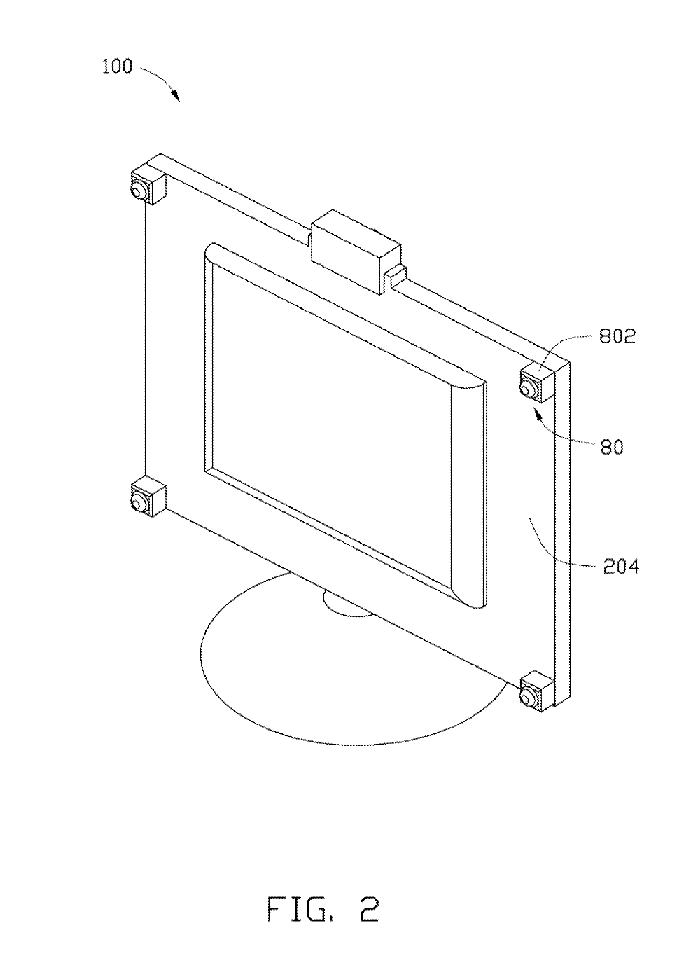

FIG. 3 is a functional block diagram of the display device of FIG. 1.

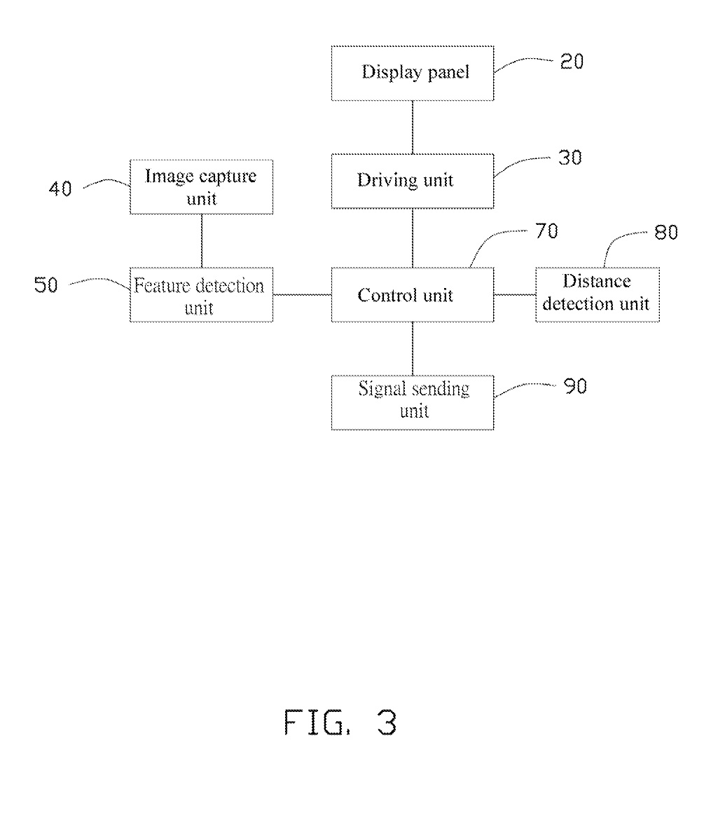

FIG. 4 is a top view of the display device of FIG. 1.

FIG. 5 shows the display device of FIG. 1 in a first state.

FIG. 6 shows a schematic image captured by an image capture unit of the display device of FIG. 1.

FIG. 7 is similar to FIG. 5, but shows the display device in a second state.

FIG. 8 is similar to FIG. 6, but shows another schematic image captured by the image capture unit of the display device of FIG. 1.

FIG. 9 is a functional block diagram of a display device, according to a second embodiment.

FIG. 10 shows a schematic image captured by an image capture unit of the display device of FIG. 9.

FIG. 11 is similar to FIG. 10, but shows another schematic image captured by the image capture unit of the display device of FIG. 9.

### DETAILED DESCRIPTION

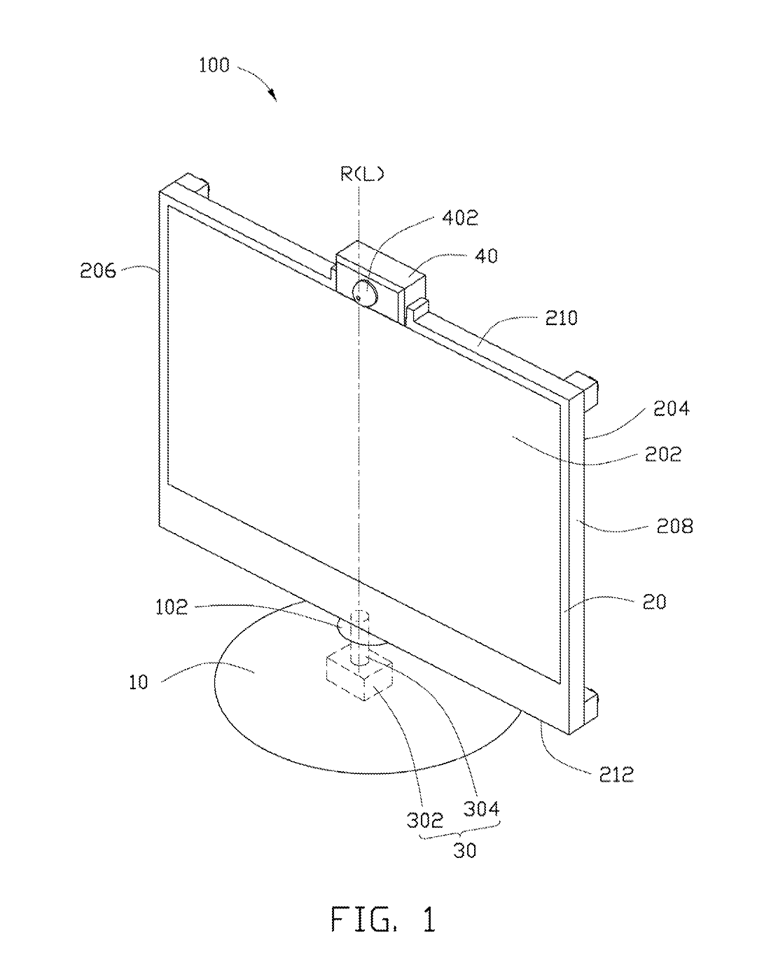

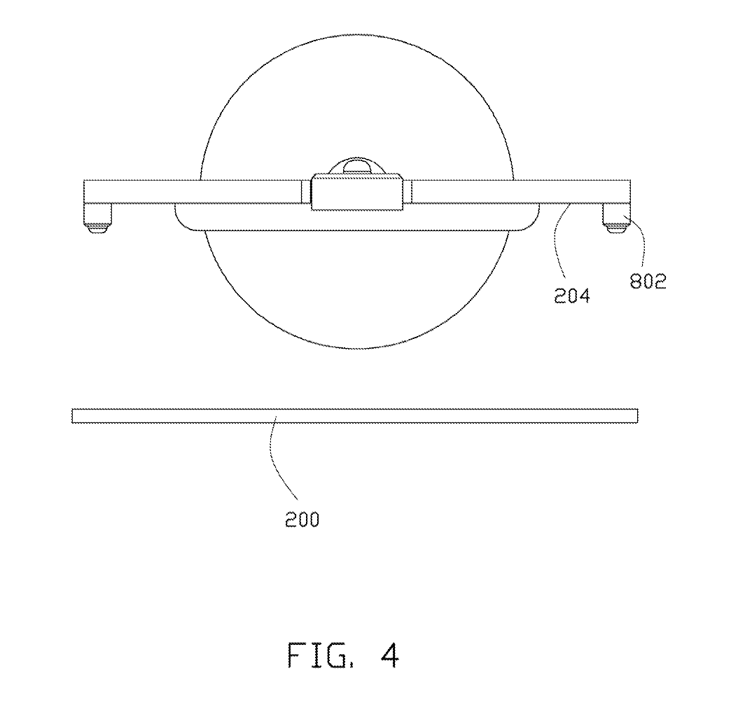

Referring to FIGS. 1 and 4, a display device 100, according to a first embodiment, includes a base 10, a display panel 20, a driving unit 30, an image capture unit 40, a feature detection unit 50 and a control unit 70.

The base 10 is substantially a truncated cone. A through hole (not shown) is defined in an upper surface 102 of the base 10.

The display panel 20 is substantially cuboid and includes a front display surface 202, a rear surface 204, a first side surface 206, a second side surface 208, a third side surface 210 and a fourth side surface 212. The first side surface 206, the second side surface 208, the third side surface 210 and the fourth side surface 212 are connected to each other end-to-end and connect the front display surface 202 and the rear surface 204. The fourth side surface 212 is rotatably mounted on the upper surface 102 of the base 10. The front display surface 202 is configured for displaying.

The driving unit 30 is connected to the display panel 20 and the base 10. The driving unit 30 is configured for rotating the display panel 20 about a rotation axis R relative to the base 10. The driving unit 30 includes a stator 302 and a rotor 304. The stator 302 is received in the base 10. The rotor 304 extends through the through hole of the base 10 and is fixedly mounted to the fourth side surface 212.

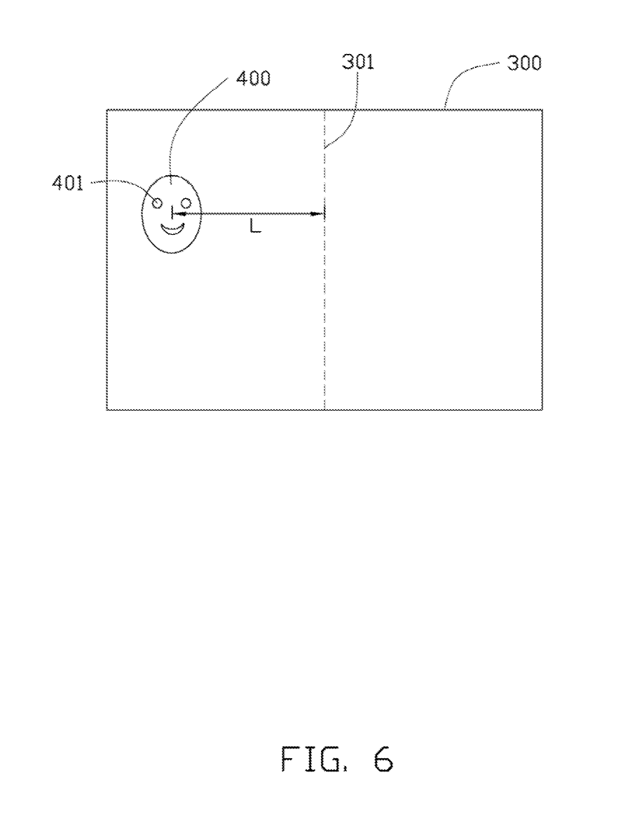

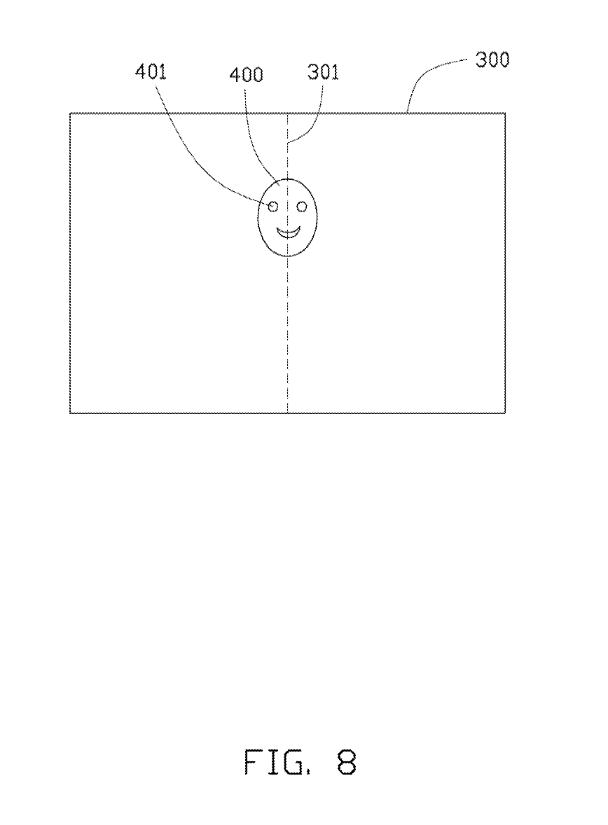

The image capture unit 40 is positioned on the display panel 20 on the rotation axis R of the display panel 20 and rotates together with the display panel 20. The rotation axis R of the display panel 20 coincides with the rotation axis of the rotor 304 and a central axis of the display panel 20. In this embodiment, the image capture unit 40 is positioned on the third side surface 210 along the rotational axis R of the display panel 20. Referring together to FIGS. 6 and 8, the image capture unit 40 is configured for capturing instant images 300 of a scene in front of the front display surface 202. The instant image 300 can be captured as following: the image capture unit 40 captures an image of the scene in front of the front display surface 202 after a predetermined duration from a previous image capture. For example, the image capture unit 40 captures the instant image 300 every second. The image capture unit 40 includes a lens module 402 and an image sensor (not shown) located at the image side of the lens module 402. An optical axis of the lens module 402 is substantially perpendicular to the front display surface 202. The instant image 300 includes a central line 301.

The feature detection unit 50 is configured for detecting a face portion 400 of a user in the instant image 300 and determining a position of the face portion 400 relative to the central line 301. The face detection can be preformed using known face detection algorithms.

The position of the face portion 400 relative to the central line 301 can be understood as a position of the face portion 400 in the instant image 300. In the illustrated embodiment, the position of the face portion 400 is at the left side of the central line 301 at a horizontal distance L. The horizontal distance L can be determined as following: the feature detection unit 50 locates two eye areas 401 in the face portion 400, and determines a horizontal distance between the central line 301 and an imaginary line perpendicular to a line segment between midpoints of the two eye areas 401. It is to be understood that other organ areas, such as a mouth area or a nose area in the face portion 400, can be used to determine the horizontal distance L.

The control unit 70 is configured for controlling the driving unit 30 to rotate the display panel 20 based on the position of the face portion so as to relocate the face portion 400 in the instant image 300 onto the central line 301.

In addition, referring to FIG. 4, when in practical use, the display panel 20 is often placed adjacent to a barrier 200, such as a wall 200. To avoid the display panel 20 hitting the wall 200, the display panel 20 further includes a distance detection unit 80 and a signal sending unit 90.

The distance detection unit 80 is configured for detecting a distance between the rear surface 204 and the barrier 200. The control unit 70 is configured for comparing the detected distance with a predetermined value. If the detected distance is less than the predetermined value, the control unit 70 controls the driving unit 30 to stop rotating the display panel 20 and controls the signal sending unit 90 to signal the user that the rotation of the display panel 20 ends. The instruction of the signal sending unit 90 may be audible and/or visible.

In this embodiment, the distance detection unit 80 includes four detectors 802. The four detectors 802 are positioned at four corners of the rear surface 204, respectively. Each detector 802 may be an infrared light detector or an acoustic wave detector and includes an emitter and a receiver.

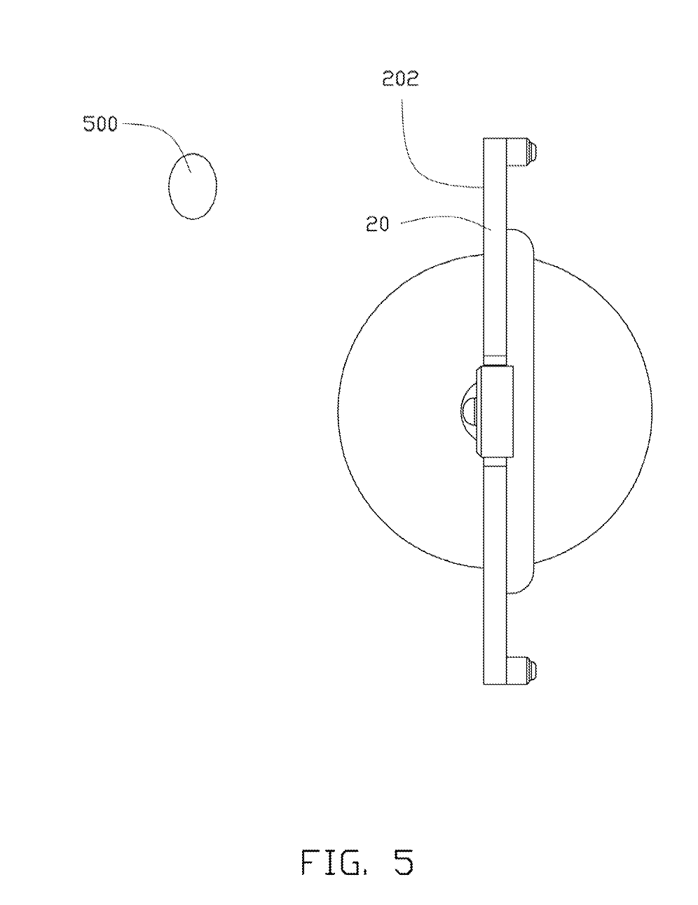

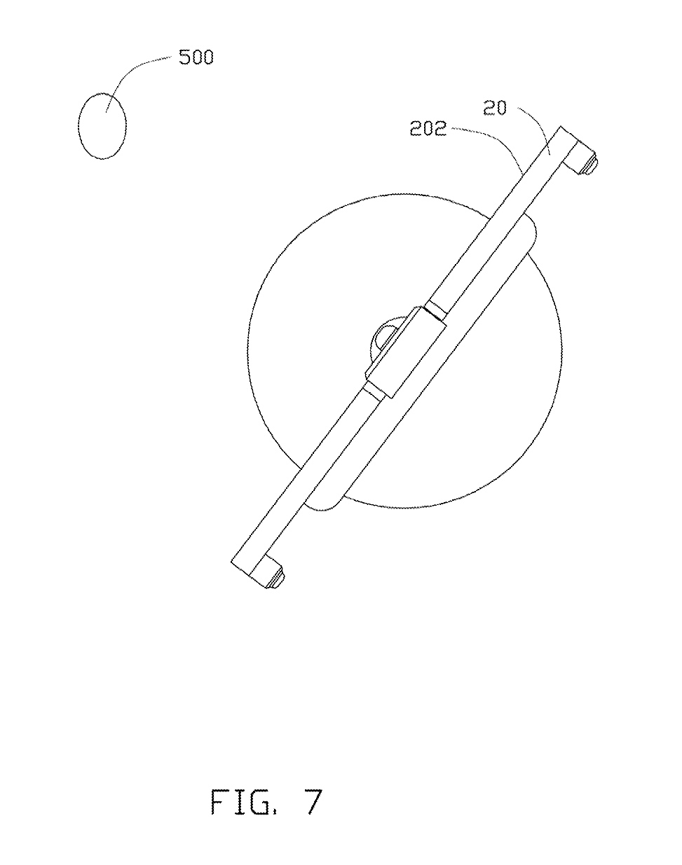

Referring to FIGS. 5 to 8 together, when in use, the image capture unit 40 captures the instant image 300 of the scene in front of the front display surface 202. The feature detection unit 50 detects the face portion 400 in the instant image 300 and determines the position of the face portion 400 relative to the central line 301. If a face 500 of the user in the scene is located at the left side of the display panel 20, the face portion 400 is located at the left side of the central line 301 correspondingly. The control unit 70 controls the driving unit 30 to rotate the display panel 20 clockwise to relocate the face portion 400 onto the central line 301, as shown in FIG. 8. After relocation, the display panel 20 orients towards the face 500, as shown in FIG. 7. Therefore, display orientation relocation/adjustment can be done automatically. This is convenient.

Furthermore, during the above process, the distance detection unit 80 detects the distance between the barrier 200 and the rear surface 204. The control unit 70 compares the detected distance with the predetermined value, and controls the driving unit 30 to stop rotating the display panel 20 if the detected distance is less than the predetermined value and controls the signal sending unit 90 to instruct the user that the rotation of the display panel 20 ends. Under this consideration, the user may move himself to another place to adapt the display orientation of the display panel 20.

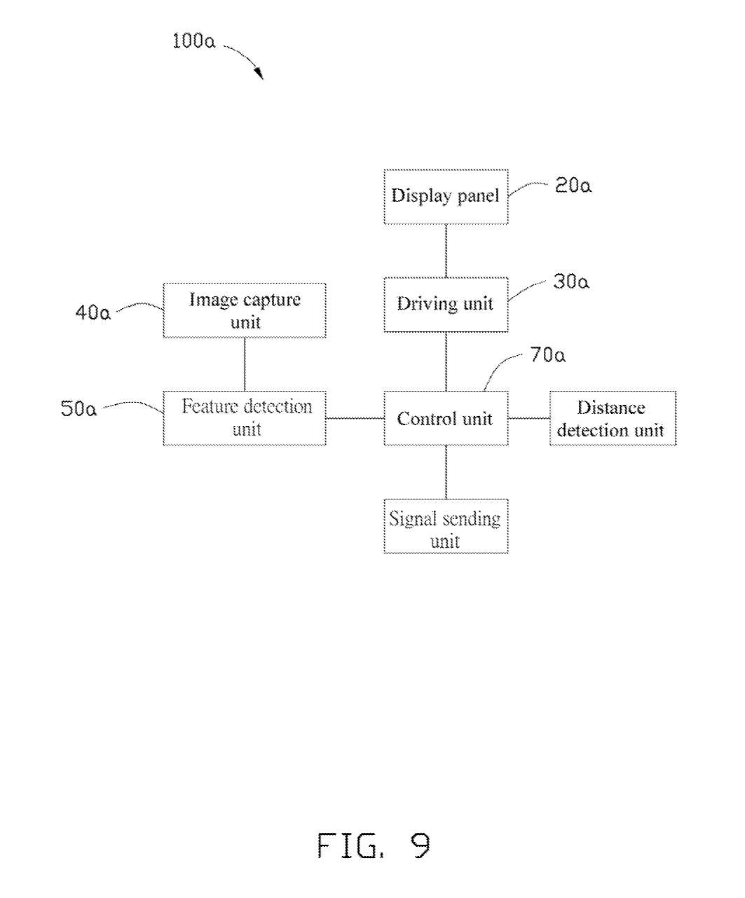

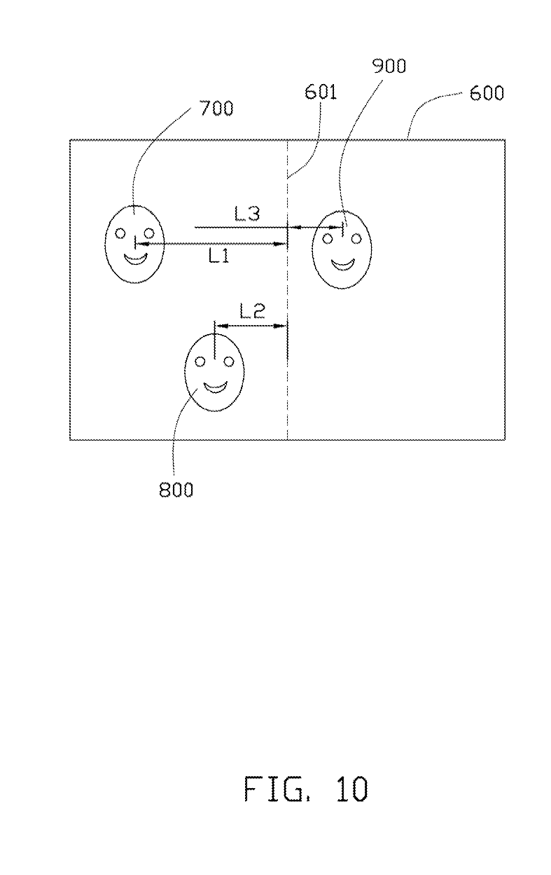

Referring to FIGS. 9 to 11, a display device 100a, according to a second embodiment, is shown. The difference between the display device 100a of this embodiment and the display device 100 of the first embodiment is that a control unit 70a of the display device 100a is different.

An image capture unit 40a captures an instant image 600 of a scene in front of a front display surface of a display panel 20a. There are three face portions 700, 800, 900 (hereafter a first face portion 700, a second face portion 800, and a third face portion 900) in the instant image 600. A feature detection unit 50a is configured for detecting the face portions 700, 800, 900 in the instant image 300 and determining a first position of the first face portion 700 relative to a central line 601 of the instant image 600, a second position of the second face portion 800 relative to the central line 601, and a third position of the third face portion 900 relative to the central line 601.

In this embodiment, the first position is that the first face portion 700 is located at the left side of the central line 601 at a first distance L1 from the central line 601. The second position is that the second face portion 800 is located at the left side of the central line 601 at a second distance L2 from the central line 601. The third position is that the third face portion 900 is located at the right side of the central line 601 at a third distance L3 from the central line 601.

The control unit 70a is configured for comparing L1, L2, L3 with each other and controlling a driving unit 30a to rotate the display panel 20a based on the comparison result to relocate a desirable face portion in the instant image 600 onto the central line 601.

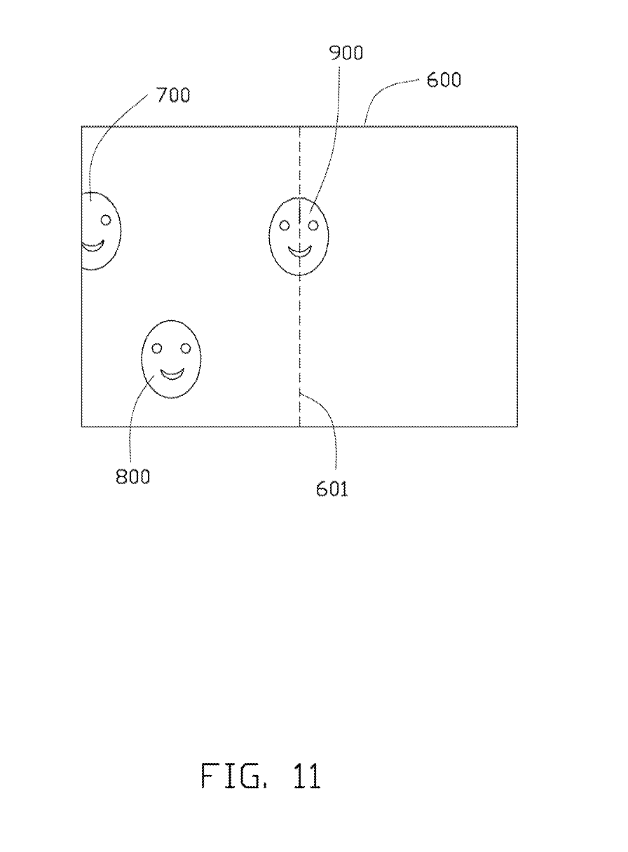

If L1>L2>L3, the control unit 70a determines the third face portion 900 as the desirable face portion and controls the driving unit 30a to rotate the display panel 20a based on the third position to relocate the third face portion 900 onto the central line 601, as shown in FIG. 11. That is, if there is a smallest value among a number of the distances, the control unit 70a determines a face portion corresponding to the smallest distance to be the desirable face portion. After rotation of the display panel 20a, the desirable face portion 900 is located on the central line 601 of the instant image 600.

If there are two or more values equaling to each other among the distances, the control unit 70a determines a face portion located on the left side of the central line 601 to be the desirable face portion. For example, if L1>L2=L3, the control unit 70a determines the second face portion 800 to be the desirable face portion.

It is to be understood that, upon other considerations, determination rules of the desirable face portion among the face portions may be pre-set in the control unit 70a according to practical uses.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A display device, comprising:
a base;
a display panel rotatably mounted on the base, the display panel comprising a front display surface;
a driving unit configured for rotating the display panel about a rotation axis relative to the base;
an image capture unit positioned on the display panel on the rotation axis, the image capturing unit configured for capturing images of a scene in front of the front display surface, the rotation axis of the display panel coinciding with a central axis of the display panel, the image comprising a central line;
a feature detection unit configured for detecting a face portion of a user in the images, and determining a position of the face portion relative to the central line; and
a control unit configured for controlling the driving unit to rotate the display panel based on the position of the face portion so as to relocate the face portion in the images onto the central line.

2. The display device of claim 1, wherein the display panel further comprises a rear surface, and wherein the display device further comprises a distance detection unit positioned on the rear surface, the distance detection unit configured for detecting a distance between a nearest barrier and the rear surface, the control unit configured for comparing the detected distance with a predetermined value and controlling the driving unit to stop rotating the display panel if the detected distance is less than the predetermined value.

3. The display device of claim 2, further comprising a signal sending unit, the control unit configured for controlling the signal sending unit to signal the user if the detected distance is less than the predetermined value.

4. The display device of claim 2, wherein the distance detection unit comprises four detectors positioned at four corners of the rear surface, respectively.

5. The display device of claim 4, wherein the detector is an infrared light detector or an acoustic wave detector.

6. The display device of claim 1, wherein the driving unit comprises a stator and a rotor, the stator being received in the base, the rotor being fixedly mounted to the display panel.

7. A method for adjusting a display orientation of the display device, the display device comprising a base, a display panel rotatably mounted on the base, and a driving unit for rotating the display panel, the display panel comprising a front display surface, the method comprising steps of:
capturing an image of a scene in front of the front display surface, the image comprising a central line;
detecting a face portion of a user in the image;
determining a position of the face portion relative to the central line; and
controlling the driving unit to rotate the display panel based on the position of the face portion to relocated the face portion onto the central line.

8. The method of claim 7, wherein the display panel further comprises a rear surface, and the method further comprises steps of:
detecting a distance between a nearest barrier and the rear surface;
comparing the detected distance with a predetermined value; and
controlling the driving unit to stop rotating the display panel if the detected distance is less than the predetermined value.

9. A display device, comprising:
a base;
a display panel rotatably mounted on the base, the display panel comprising a front display surface;
a driving unit configured for rotating the display panel about a vertical axis;
an image capture unit positioned on the display panel, the image capturing unit configured for capturing an image of a scene in front of the front display surface, the image capture unit located on a central axis of the display panel, the image comprising a central line;
a feature detection unit configured for detecting face portions of users in the image, and determining positions of the face portions relative to the central line; and
a control unit configured for controlling the driving unit to rotate the display panel based on the positions of the face portions so as to relocate at least one of the face portions onto the central line.
